(19) United States
(12) Patent Application Publication
(10) Pub. No.: US 2026/0167374 A1
(43) Pub. Date: Jun. 18, 2026

(54) Receiving Apparatus for a Label Carrier Tape of a Labeling Apparatus for Containers

(71) Applicant: Krones AG, Neutraubling (DE)

(72) Inventor: Christian UEHLIN, Zeitlarn (DE)

(21) Appl. No.: 19/421,780

(22) Filed: Dec. 16, 2025

(30) Foreign Application Priority Data
Dec. 17, 2024 (DE) 102024138404.2

(51) Int. Cl. B65C 9/18; B65H 18/10; B65H 35/02

(52) U.S. Cl. CPC B65C 9/1892; B65C 9/1803; B65C 9/1865; B65H 18/10; B65H 35/02; B65H 2801/75

(57) ABSTRACT

A receiving apparatus for a label carrier tape of a labeling apparatus for containers. The receiving apparatus includes a feeding apparatus and a receiving unit. The feeding apparatus can feed the label carrier tape to the receiving unit. The receiving unit includes a winding shaft which can be set in rotation by a drive apparatus. The label carrier tape can be wound onto the winding shaft in a receiving position into a winding roll. The winding shaft is configured to be moved in a first direction parallel to an axis of rotation of the winding shaft. The winding roll can be moved from the receiving position to a rest position by moving the winding shaft. The incoming label carrier tape can be wound onto a further winding roll in the receiving position.

### CROSS-REFERENCE TO RELATED APPLICATIONS

This application claims priority to, and the benefit of, German Patent Application No. 102024138404.2, filed Dec. 17, 2024, the contents of which are incorporated by reference herein in their entirety.

### TECHNICAL FIELD

The present invention relates to a receiving apparatus for a label carrier tape of a labeling apparatus for containers.

### BACKGROUND

Receiving apparatuses for label carrier tapes of a labeling apparatus for containers are known from the prior art.

It is also known to wind a label carrier tape onto a winding roll after the labels have been applied to the containers. When the winding roll has absorbed a certain maximum length of label carrier tape and thus its maximum storage capacity has been reached, it must be replaced. In the prior art, to change the winding roll, the operation of the labeling apparatus is typically stopped so that no more label carrier tape is fed to the winding roll and the winding roll can be replaced by an empty winding roll. Furthermore, it is known to change the winding roll during the operation of the labeling machine, wherein in this case the label carrier tape is no longer wound onto a winding roll, but is conveyed in an unordered manner onto a surface associated with the labeling apparatus.

Both approaches have disadvantages. Thus, when the labeling machine is stopped to change the winding roll, the throughput of containers labeled per unit of time is reduced. When the label carrier tape is conveyed in a disordered manner onto a surface associated with the labeling apparatus, additional processing steps are necessary, as the disorderly conveyed label carrier tape must first be made orderly and wound up, for example by an operator of the plant. Furthermore, unwanted disturbance in the receiving apparatus can occur due to the disorderly conveying of the label carrier tape.

### BRIEF SUMMARY

One aspect of the invention relates to a receiving apparatus for a label carrier tape of a labeling apparatus which allows continuous receiving of a label carrier tape provided by a labeling apparatus.

A receiving apparatus according to this aspect of the invention for a label carrier tape of a labeling apparatus for containers comprises a feeding apparatus and a receiving unit, wherein the feeding apparatus can feed the label carrier tape to the receiving unit, the receiving unit comprises a winding shaft which can be set in rotation by a drive apparatus, and the label carrier tape can be wound onto the winding shaft in a receiving position into a winding roll, wherein the winding shaft is configured to be moved in a first direction parallel to an axis of rotation of the winding shaft, the winding roll can be moved from the receiving position to a rest position by moving the winding shaft, and the incoming label carrier tape can be wound onto a further winding roll in the receiving position.

A label carrier tape can be understood as a carrier tape that is suitable for receiving labels. The labels received by the label carrier tape can be applied to the containers in the labeling apparatus. For this purpose, the label carrier tape can, for example, be pulled over a dispensing edge, wherein the labels can be detached from the tape by the strong deflection at the dispensing edge and transferred to the containers. The empty label carrier tape, i.e., the label carrier tape without labels, can then be received by the receiving apparatus and stored in it.

The term winding shaft can refer to any rotatable holding apparatus for the label carrier tape, on which the label carrier tape can be wound into a winding roll. The winding shaft can, for example, have a cylindrical shape and be configured to rotate, so that the label carrier tape can be wound onto the winding shaft to form a winding roll.

The term “winding roll” can refer to the label carrier tape wound into a roll.

By moving the winding shaft along the first direction, a winding roll wound on the winding shaft and held by the winding shaft can be moved from the receiving position to the rest position. The receiving position and the rest position can be understood as stationary positions in the receiving apparatus, between which the winding roll can be moved by the winding shaft. The receiving position and the rest position can be fixed, for example, before the receiving apparatus is put into operation, but can also be flexibly adjusted, for example, during the operation of the receiving apparatus.

The receiving position can be understood as a position in the receiving apparatus at which the label carrier tape fed by the feeding apparatus of the receiving unit is wound onto the winding shaft to form a winding roll.

The rest position can be understood as a position in the receiving apparatus in which the label carrier tape, already wound onto a winding roll, can be held on the winding shaft after the winding shaft has moved along the first direction, but no further winding of the label carrier tape fed by the feeding apparatus takes place.

A movement/shifting of the winding shaft along the first direction parallel to the axis of rotation of the winding shaft may comprise moving the winding shaft along the axis of rotation. A movement/shifting of the winding shaft along the second direction antiparallel to the axis of rotation of the winding shaft may comprise moving the winding shaft along the axis of rotation, opposite to the first direction.

By moving the winding roll from the receiving position to the rest position, a region of the winding shaft on which no label carrier tape is yet wound can simultaneously be moved into the receiving position. On this empty region of the winding shaft, on which no label carrier tape has yet been wound and which is now in the receiving position, the label carrier tape coming from the feeding apparatus can then be wound onto another new winding roll in the receiving position. The receiving position and rest position can have a distance between them that is chosen so that a winding roll in the rest position and a winding roll in the receiving position do not touch each other and/or optionally have a distance of up to 1 cm or up to 9.5 cm.

By moving the winding shaft along the first direction, the winding roll wound on the winding shaft can be moved from the receiving position to the rest position, and the label carrier tape can be wound onto another winding roll in the receiving position. In this way, continuous receiving of the label carrier tape by the receiving apparatus can be ensured, since even when a winding roll reaches its maximum receiving capacity in the receiving position, it can be shifted to the rest position and the label carrier tape entering from the labeling apparatus can be wound onto a new winding roll in the receiving position.

In one embodiment, the feeding apparatus may comprise at least one pressure roll arranged along a direction parallel to the axis of rotation of the winding shaft, wherein a first pressure roll is provided in a region of the receiving position to press the label carrier tape against the winding shaft or the winding roll in the receiving position, wherein the first pressure roll can be deflected in a plane perpendicular to the axis of rotation of the winding shaft, wherein optionally a second pressure roll is provided in the region of the rest position to press the label carrier tape against the winding roll in the rest position, wherein the second pressure roll can be deflected in a plane perpendicular to the axis of rotation of the winding shaft. The first pressure roll securely fixes the label carrier tape to the winding shaft and/or the winding roll in the receiving position, thus allowing proper winding of the label carrier tape into a winding roll. The optional second pressure roll allows the unwound portion of the label carrier tape to be fixed to the winding roll after it has been shifted into its rest position, thus preventing unwanted unwinding of the label carrier tape.

In a development, the receiving apparatus can comprise a control unit, wherein the control unit is configured to move the first pressure roll in the region of the receiving position from a pressure position to a release position in order to allow the movement of the winding roll from the receiving position to the rest position, wherein the control unit is configured, after the movement of the winding roll from the receiving position to the rest position, to move the first pressure roll in the region of the receiving position to the winding shaft in order to press the incoming label carrier tape against the winding shaft and optionally to move the second pressure roll in the region of the rest position to the winding shaft in order to press the label carrier tape against the winding roll in the region of the rest position. By moving the first pressure roll from the pressure position to the release position, there is no longer any contact between the pressure and winding rolls, thus allowing the winding roll to move from the receiving position to the rest position and allowing the label carrier tape to be wound onto the further winding roll in the receiving position. The second pressure roll can be used to fix an end region of the label carrier tape of the winding roll in the rest position on the winding roll and prevent unwanted unwinding of the label carrier tape from the winding roll. Furthermore, by fixing the label carrier tape to the winding shaft at the receiving position, the incoming label carrier tape can be wound into a new winding roll.

In a development of the preceding embodiment, it can be provided that the feeding device comprises a severing apparatus, wherein the label carrier tape between the winding roll in the rest position and the winding roll in the receiving position can be severed by the severing apparatus, and the severing apparatus comprises a guide disc for guiding the separated label carrier tape and/or the winding roll in the rest position, wherein the control unit can be configured to move the winding shaft along a second direction, which runs antiparallel to the first direction, in order to release the winding roll held by the winding shaft in the rest position from the winding shaft and to guide the released winding roll out of the receiving apparatus. The severing apparatus allows the winding roll in the rest position and the winding roll in the receiving position to be separated from each other. Thus, the winding roll in its rest position can, for example, be removed from the receiving apparatus without hindrance, creating space for receiving another winding roll.

In a development of the preceding embodiment, the receiving unit can comprise a flange, wherein the flange surrounds the winding shaft and a plane of the flange is substantially perpendicular to the axis of rotation of the winding shaft, wherein the flange is arranged stationary with respect to the first and second directions, wherein the winding roll in the receiving position can be held in the receiving position by the flange when the winding shaft is shifted along the second direction and shifting of the winding roll can be prevented. Substantially perpendicular can be understood to mean that the axis of rotation of the winding shaft and the plane of the flange are perpendicular to each other, or that the angle between the axis of rotation and the plane of the flange is between 89° and 91° or between 86° and 94°. The flange prevents unwanted shifting of the winding roll in the receiving position along the second direction when the winding shaft is moved along the second direction. This ensures that the label carrier tape can be wound onto the winding roll held in the receiving position even while the winding shaft is being removed in its rest position.

In a development of the previous embodiment, the winding shaft can comprise at least two winding shaft profile strips, wherein one of the at least two winding shaft profile strips is fixedly arranged in a first recess of a surface region of the winding shaft along the axis of rotation, wherein a profile of the at least two winding shaft profile strips projects radially beyond a main body of the winding shaft, wherein the flange comprises at least two flange profile strips, wherein the at least two flange profile strips are fixedly connected to the flange, and wherein one of the at least two flange profile strips can be movably guided along the axis of rotation of the winding shaft in a second recess of the winding shaft, wherein a profile of the at least two flange profile strips projects radially beyond the main body of the winding shaft of the winding shaft, wherein the winding roll is at least partially wound onto the at least two flange profile strips in the receiving position, and wherein, when the winding roll is shifted from the receiving position to the rest position, the winding roll can be stripped off the at least two flange profile strips by the at least two winding shaft profile strips. Because the winding roll is at least partially wound over the at least two flange profile strips in the receiving position, and the profile of the two flange profile strips extends beyond the main body of the winding shaft, the label carrier tape rests against the main body of the winding shaft on a surface between two flange profile strips during winding. In this way, it can be ensured that the tape tension in the inner layers of the winding roll does not increase significantly even with an increasing diameter of the label carrier tape wound onto the winding roll. The winding roll can be safely stripped from the winding shaft thanks to at least two winding shaft profile strips.

It may further be provided that the receiving apparatus comprises a sensor apparatus, preferably an ultrasonic sensor, for determining a parameter related to the winding of the label carrier tape onto the winding roll in the receiving position, wherein the control unit is configured to move the winding shaft along the first direction or the second direction based on the parameter. The parameter associated with winding the label carrier tape onto the winding roll in the receiving position can be, for example, the length of the label carrier tape wound onto the winding roll, the diameter of the winding roll, or the weight of the winding roll. By providing the sensor apparatus, it is possible to prevent more label carrier tape from being fed to the winding roll in the receiving position than it can hold, thus preventing possible disturbance of the receiving apparatus.

In one embodiment, the receiving apparatus can comprise an apparatus for reducing the label carrier tape width, wherein the apparatus for reducing the label carrier tape width is arranged upstream of the feeding apparatus, and wherein the apparatus for reducing the label carrier tape width is optionally configured as a cutting apparatus or as a folding apparatus. This allows the receiving apparatus to be flexibly operated with different label carrier tape widths and therefore also with different labeling apparatuses.

According to the invention, a method for receiving a label carrier tape of a labeling apparatus for containers into a receiving apparatus is further provided, wherein the receiving apparatus includes a feeding apparatus and a receiving unit and the feeding apparatus feeds the label carrier tape to the receiving unit, wherein the receiving unit comprises a winding shaft which can be set in rotation by a drive apparatus. The method comprises winding the label carrier tape onto the winding shaft in a receiving position into a winding roll, wherein the winding shaft is moved at least temporarily in a first direction parallel to an axis of rotation of the winding shaft, wherein the winding roll is moved from the receiving position to a rest position by moving the winding shaft and the incoming label carrier tape is wound onto a further winding roll in the receiving position.

By moving the winding shaft along the first direction, the winding roll wound on the winding shaft is moved from the receiving position to the rest position, and the label carrier tape is wound into another winding roll in the receiving position. In this way, continuous receiving of the label carrier tape by the receiving apparatus can be ensured, since even when a winding roll reaches its maximum receiving capacity in the receiving position, the winding roll can be shifted to the rest position and the label carrier tape entering from the labeling apparatus can be wound onto a new winding roll in the receiving position.

It may further be provided that the feeding apparatus may comprise at least one pressure roll arranged along a direction parallel to the axis of rotation of the winding shaft, wherein a first pressure roll is provided in a region of the receiving position to press the label carrier tape against the winding shaft or the winding roll in the receiving position, wherein the first pressure roll can be deflected in a plane perpendicular to the axis of rotation of the winding shaft, wherein optionally a second pressure roll is provided in the region of the rest position to press the label carrier tape against the winding roll in the rest position, wherein the second pressure roll can be deflected in a plane perpendicular to the axis of rotation of the winding shaft. The first pressure roll securely fixes the label carrier tape to the winding shaft, ensuring that the label carrier tape is properly wound onto a winding roll. The optional second pressure roll allows the unwound portion of the label carrier tape to be fixed to the corresponding winding roll after it has been shifted into its rest position, thus further preventing unwinding of the label carrier tape.

In a further development, the receiving apparatus can comprise a control unit, and the first pressure roll is moved by the control unit from a pressure position to a release position in the receiving position region to allow the winding roll to move from the receiving position to the rest position, wherein once the winding roll has moved from the receiving position to the rest position, the first pressure roll is moved by the control unit in the receiving position region to the winding shaft to press the incoming label carrier tape against the winding shaft, and optionally the second pressure roll is moved in the rest position region to the winding shaft to press the label carrier tape against the winding roll in the rest position region. By moving the first pressure roll from the pressure position to the release position, there is no longer any contact between the winding roll and the pressure roll, which allows the winding roll to move from the receiving position to the rest position and the label carrier tape to be wound onto the further winding roll in the receiving position. The second pressure roll can be used to fix an end region of the label carrier tape of the winding roll in the rest position on the winding roll and prevent unwanted unwinding of the label carrier tape from the winding roll. Furthermore, by fixing the label carrier tape to the winding shaft at the receiving position using the first pressure roll, the incoming label carrier tape can be wound into a new winding roll.

In a development of the preceding embodiment, the feeding device can comprise a severing apparatus, wherein the label carrier tape between the winding roll in the rest position and the winding roll in the receiving position is severed by the severing apparatus, and the severing apparatus comprises a guide disc for guiding the separated label carrier tape and/or the winding roll in the rest position, wherein the winding shaft is moved by the control unit along a second direction, which runs antiparallel to the first direction, and the winding roll held by the winding shaft in the rest position is released from the winding shaft and the released winding roll is guided out of the receiving apparatus. By the severing apparatus, the winding roll in the rest position and the winding roll in the receiving position can be physically separated from each other in such a way that it is possible to properly remove the winding roll held in the rest position from the receiving apparatus.

In one embodiment, the receiving unit can comprise a flange which surrounds the winding shaft and in which a plane of the flange is substantially perpendicular to an axis of rotation of the winding shaft, wherein the flange is arranged stationary with respect to the first and second directions and the winding roll in the receiving position is held in the receiving position by the flange when the winding shaft is shifted along the second direction and shifting of the winding roll is prevented. The flange prevents unwanted shifting of the winding roll along the second direction when the winding shaft is moved along the second direction and ensures proper winding of the label carrier tape onto the winding roll in the receiving position even when the winding shaft is moved.

In a development of the previous embodiment, the winding shaft can comprise at least two winding shaft profile strips, wherein one of the at least two winding shaft profile strips is fixedly arranged in a first recess of a surface region of the winding shaft along the axis of rotation, wherein a profile of the at least two winding shaft profile strips projects radially beyond a main body of the winding shaft, wherein the flange comprises at least two flange profile strips, wherein the at least two flange profile strips are fixedly connected to the flange, and wherein one of the at least two flange profile strips can be movably guided along the axis of rotation of the winding shaft in a second recess of the winding shaft, wherein a profile of the at least two flange profile strips projects radially beyond the main body of the winding shaft, wherein the winding roll is at least partially wound onto the at least two flange profile strips in the receiving position, and wherein, when the winding roll is shifted from the receiving position to the rest position, the winding roll can be stripped off the at least two flange profile strips by the at least two winding shaft profile strips. Because the winding roll is at least partially wound over the at least two flange profile strips in the receiving position, and the profile of the two winding shaft profile strips extends beyond the main body of the winding shaft, the label carrier tape rests against the main body of the winding shaft on a surface between two flange profile strips during winding. In this way, it can be ensured that the tape tension in the inner layers of the winding roll does not increase significantly even with an increasing diameter of the label carrier tape wound onto the winding roll. The winding roll can be safely stripped from the winding shaft thanks to at least two winding shaft profile strips.

It may further be provided that the receiving apparatus comprises a sensor apparatus, preferably an ultrasonic sensor, for determining a parameter related to the winding of the label carrier tape onto the winding roll in the receiving position, wherein the winding shaft is moved along the first direction or the second direction by the control unit based on the parameter. By providing the sensor apparatus, it is possible to prevent more label carrier tape from being fed to the winding roll in the receiving position than it can hold, thus preventing possible disturbance of the receiving apparatus.

### BRIEF DESCRIPTION OF THE FIGURES

FIG. 1 is a schematic diagram of a receiving apparatus for a label carrier tape of a labeling apparatus in accordance with an embodiment.

FIGS. 2a and 2b are schematic diagrams of a receiving apparatus for a label carrier tape of a labeling apparatus in accordance with a further embodiment.

FIGS. 3a and 3b are perspective views of a winding shaft in accordance with one embodiment.

### DETAILED DESCRIPTION

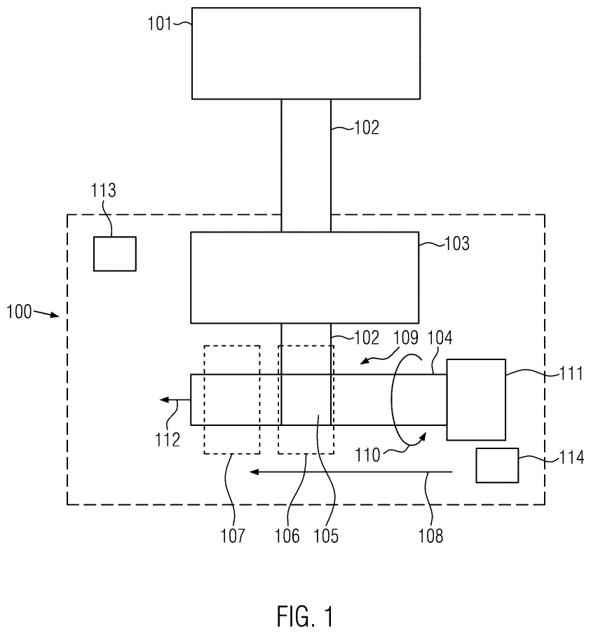

FIG. 1 shows a receiving apparatus 100 for a label carrier tape 102 of a labeling apparatus 101 in accordance with an embodiment.

According to the invention, the receiving apparatus 100 comprises a feeding apparatus 103 and a receiving unit 109, wherein the feeding apparatus 103 can feed the label carrier tape 102 to the receiving unit 109. According to the invention, the receiving unit 109 comprises a winding shaft 104 which can be set into rotation 110 via a drive apparatus 111, wherein the label carrier tape 102 can be wound onto the winding shaft 104 in a receiving position 106 into a winding roll 105. The drive apparatus 111 can be encompassed by the receiving unit 109.

According to the invention, the winding shaft 104 is configured to be moved in a first direction 108 parallel to an axis 112 of rotation of the winding shaft 104. By moving the winding shaft along the first direction, the winding roll 105 wound on the winding shaft can be moved from the receiving position 106 to a rest position 107 and the incoming label carrier tape 102 can be wound into another winding roll in the receiving position 106.

The winding shaft 104 can, for example, be a cylindrically shaped shaft which has a length along the axis of rotation 112 that is at least twice the width of the label carrier tape 102. This ensures that two adjacent winding rolls 105, one in the receiving position 106 and one in the rest position 107, can be received by the winding shaft 104. The winding shaft 104 can be mounted in a housing, not shown here, in a movable manner in order to be able to move the winding shaft 104 along the first direction 108.

The drive apparatus 111 can be an electric motor, for example. The electric motor can be configured as a servo motor, for example. The servo motor can, for example, be connected via a belt to a gear attached to the winding shaft, so that a rotation of a rotor of the servo motor can be transmitted to the winding shaft via the belt.

The receiving unit 109 can furthermore comprise a pneumatic drive (not shown here) by which the winding shaft 104 can be moved along the first direction 108. Alternatively, for example an electric linear drive can be provided for moving the winding shaft 104.

The labeling apparatus 101 can be a labeling apparatus for containers in which the containers can be labeled by labels located on the label carrier tape 102. To label the containers, the labels are removed from the label carrier tape 102 in the labeling apparatus 101 and transferred to the containers. This can be achieved, for example, by redirecting the label carrier tape 102 with the labels over a dispensing edge, so that during redirection the labels can be detached from the label carrier tape and applied to the containers. The empty label carrier tape, i.e., the label carrier tape without labels, can then be guided from the labeling apparatus 101 to the feeding apparatus 103 of the receiving apparatus 100, which in turn guides the label carrier tape 102 to the receiving unit 109 for storing the label carrier tape.

The receiving unit 109 can be flexibly operated with a variety of different labeling apparatuses. The labeling apparatus can be, for example, a labeling apparatus for containers.

In order to feed the label carrier tape 102 to the receiving unit 109 and to process the label carrier tape 102 in the receiving unit 109, the feeding apparatus 103 can comprise at least one pressure roll. For example, at least one pressure roll can be configured to press the label carrier tape onto the winding shaft and/or the winding roll and/or to guide or steer the label carrier tape.

The at least one pressure roll can be arranged along a direction parallel to the axis of rotation 112 of the winding shaft 104.

A first pressure roll can be provided in a region of the receiving position 106 to press the label carrier tape onto the winding shaft 104 or the winding roll 105 at the receiving position 106. Optionally, a second pressure roll can also be provided in the region of the rest position 107 to press the label carrier tape 102 against the winding roll 105 at the rest position 107. It may be provided that the first and the optional second pressure roll can be deflected in a plane which is perpendicular to the axis of rotation 112 of the winding shaft 104. In this way, the pressure rolls can be moved flexibly between a position where they are in contact with the winding shaft 104 or the winding roll and a position where they are not in contact with the winding shaft 104 or the winding roll. If, for example, the pressure roll is not in contact with the winding roll 105, the winding shaft 104 can be moved along the first direction 108. Contact between the winding roll and the pressure roll ensures that the label carrier tape 102 can be wound securely.

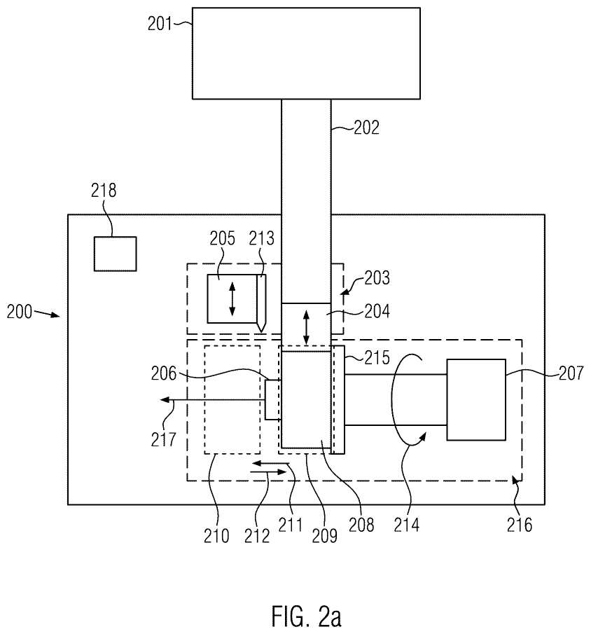

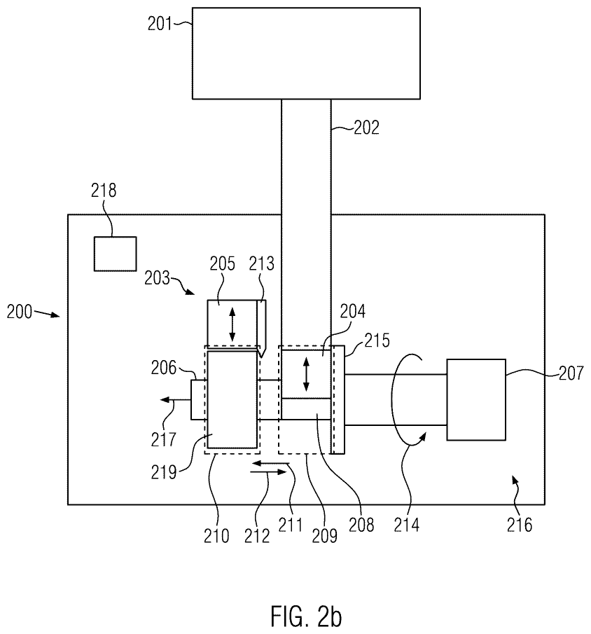

A more specific embodiment of the feeding apparatus is described in conjunction with the embodiment shown in FIGS. 2a and 2b.

To control the deflection of at least one pressure roll, the receiving apparatus can comprise a control unit 113. The control unit can comprise a processor and a storage apparatus for this purpose. The storage apparatus (such as a non-volatile memory) can store, for example, a large number of different process steps, such as winding the label carrier tape 102 onto a winding roll 105 in the receiving position 106 or shifting the winding shaft 104 along the first direction 108, and different deflection values for the at least one pressure roll.

The control unit 113 can also be used to control other components of the receiving apparatus 100.

By shifting the winding roll 105 from the receiving position 106 to the rest position 107, the label carrier tape 102 entering the receiving unit 109 from the labeling apparatus 101 via the feed apparatus 103 can be wound onto another new winding roll in the receiving position 106. In this way, for example, when the maximum receiving capacity of the winding roll 105 in the receiving position 106 is reached, the label carrier tape 102 can be wound onto a new winding roll in the receiving position 106, thus achieving continuous receiving of the label carrier tape by the receiving unit 109. In this way, the upstream labeling apparatus 101 can also be operated continuously, and a stopping of the labeling apparatus 101 and a corresponding reduction in the number of containers labeled per unit of time when a maximum receiving capacity of a winding roll 105 in the receiving position 106 is reached can be prevented.

The receiving apparatus 100 can further comprise a sensor apparatus 114 for determining a parameter related to the winding of the label carrier tape onto the winding roll 105 in the receiving position 106, wherein the control unit 113 is configured to move the winding shaft 104 along the first direction based on the parameter. Furthermore, the control unit 113 can be configured to move the winding shaft 104 along a second direction, which runs antiparallel to the first direction 108, based on the parameter. In this way, it can be effectively prevented that too much label carrier tape 102 is fed to the winding roll 105 in the receiving position 106 and a potential disturbance of the receiving apparatus 100 can be prevented.

The parameter related to receiving the label carrier tape can be, for example, the length of the label carrier tape 102 wound onto the winding roll 105 in the receiving position 106, the diameter of the winding roll 105 in the receiving position 106, or the weight of the winding roll 105 in the receiving position 106.

The sensor apparatus 114 can, for example, be a sensor which comprises a measuring wheel for determining the length of the label carrier tape wound onto the winding roll. Alternatively, the sensor apparatus 114 can also be an ultrasonic sensor for determining the diameter of the winding roll or a weight sensor configured to determine the weight of the winding roll.

The storage apparatus of the control unit 113 described above can contain a database with a first threshold value for a number of different parameters related to the receiving of the label carrier tape 102. By comparing the measured values measured using the sensor apparatus 114 and the corresponding first threshold values stored in the storage apparatus, the control unit 113 can determine when the winding roll has reached a maximum receiving capacity for label carrier tape and no further label carrier tape can be wound onto the winding roll.

The control unit 113 can move the winding shaft 104 along the first direction 108 based on the parameter associated with receiving the label carrier tape, for example as described above by comparing the parameter with a first threshold value. In this way, the winding roll 105 can be moved from the receiving position 106 to the rest position 107 and the label carrier tape 102 fed via the feeding apparatus 103 can be wound up to a new winding roll 105 in the receiving position 106.

The receiving apparatus 100 can further comprise a severing apparatus which is configured to cut the label carrier tape 102 between the winding roll in the receiving position 106 and the winding roll in the rest position 107.

The control unit 113 can further be configured to move the winding shaft 104 along the second direction, which runs antiparallel to the first direction 108, in order to release the winding roll held by the winding shaft 104 in the rest position 107 from the winding shaft 104 and to guide the released winding roll out of the receiving apparatus 100.

The control unit 113 can also be configured to compare a parameter related to the winding of the label carrier tape onto the winding shaft 104 with a second threshold value and to move the winding shaft along the second direction based on the comparison. For example, the second threshold value can be chosen to correspond to one third, half or two thirds of the maximum receiving capacity of the winding roll 105 in the receiving position 106 on the label carrier tape. However, the threshold value can also correspond to any other value which is less than or equal to a maximum receiving capacity of the corresponding winding roll 105 in the receiving position 106. Thus, before the winding roll in the receiving position 106 reaches a maximum receiving capacity, the winding roll in the rest position 107 can be removed from the receiving apparatus 100 and the winding roll 105 in the receiving position 106 can be shifted to the rest position 107, for example when a maximum receiving capacity is reached, by moving the winding shaft along the first direction 108 and the label carrier tape can be wound onto another winding roll in the receiving position 106. This process can be repeated as often as desired, so that continuous receiving of the label carrier tape 102 by the receiving apparatus 100 can be achieved.

The receiving apparatus 100 can comprise an opening housing in which the feeding apparatus 103 and the receiving unit 109 can be housed. The housing can, for example, comprise a first opening into which the label carrier tape 102 coming from the labeling apparatus 101 can be fed to the feeding apparatus 103. Furthermore, the housing can comprise a second opening through which a winding roll can be guided out of the housing in the rest position when the winding shaft 104 is moved along the second direction.

Optionally, the receiving apparatus 100 can comprise an apparatus for reducing the label carrier tape width, by which the width of the label carrier tape can be reduced before it is fed to the feeding apparatus 103 from the labeling apparatus 101. The apparatus for reducing the label carrier tape width can also be arranged as a separate apparatus upstream of the receiving apparatus 100 with respect to a transport direction of the label carrier tape 102. For example, it may be possible to reduce the width of a label carrier tape 102 of which the width exceeds a certain limit value. The limit value can be, for example, 80 mm, 100 mm or 150 mm. These given limit values are to be understood as examples, so that the limit value can also take on any other value.

The apparatus for reducing the label carrier tape width can, for example, be configured as a folding apparatus.

The folding apparatus may, for example, comprise a folding component which may be configured to fold the label carrier tape inwards on at least one or both sides. For example, the folding component can be configured to fold the label carrier tape in such a way that the width of the label carrier tape is reduced by half. However, it may also be provided that the width of the label carrier tape can be adjusted to any other width which has a value between an original width of the label carrier tape (the width which the label carrier tape has upstream of the folding apparatus) and half the original width. The width of the label carrier tape can be understood as a dimension of the label carrier tape which is perpendicular to a guide direction of the label carrier tape and lies in a guide plane of the label carrier tape.

Alternatively, the apparatus for reducing the label carrier tape width can also be configured as a cutting apparatus. The cutting apparatus may further comprise a deflecting apparatus by which a portion of the label carrier tape separated from the label carrier tape can be guided under a continuous portion of the label carrier tape. For example, the cutting apparatus may be configured to sever the label carrier tape at a position corresponding to half the label carrier tape width. In this way, two partial label carrier strips of the same width can be produced. One of the partial label carrier tapes can continue to be guided along the guide direction towards the winding shaft, and the other separated part of the label carrier tape can be placed under or on top of the part of the label carrier tape that continues to be guided along the guide direction by deflecting apparatuses. The two overlapping partial label carrier strips can then be fed to the winding shaft. In this way, the width of the label carrier tape can be halved. However, it may also be provided that the label carrier tape is cut at any other position. For example, it may also be provided that the label carrier tape is cut at a position that corresponds to one third or one quarter of the width of the label carrier tape.

A buffer apparatus may also be provided upstream of the receiving apparatus 100 and downstream of the labeling apparatus 101, by which any speed fluctuations that may occur in the label carrier tape 102 can be compensated.

Furthermore, a tensioning apparatus downstream of the buffer apparatus can be provided, which can control the tape tension of the label carrier tape.

The tensioning apparatus can, for example, be configured to control the tape tension based on the parameter associated with winding the label carrier tape onto the winding roll in the receiving position.

For example, it may be provided that the tape tension is reduced as the diameter of the label carrier tape wound onto the winding shaft in the receiving position increases. It can also be provided that the tape tension is reduced as the length of the label carrier tape fed to the winding shaft via the feeding apparatus increases. For example, in this case the band tension can be reduced linearly with increasing diameter of the winding roll. However, any other functional relationship between tape tension and diameter of the label carrier tape wound up in the receiving position can also exist, which describes a decrease in tape tension with increasing diameter of the wound-up label carrier tape.

Alternatively, it can also be provided that the label carrier tape is initially wound onto the winding shaft with a first tape tension. The first band voltage can be constant over time, or it can increase over time. Once the winding roll has reached a certain first diameter, or once a certain length of label carrier tape has been wound onto the winding shaft by the feeding apparatus, the tape tension can be increased to a second tape tension value and then reduced again to a third tape tension value. The tape tension can be increased in steps from the first tape tension to the second tape tension. However, it can also be provided that the tape tension is continuously increased from the first tape tension to the second tape tension. Reducing the tape tension from the second tape tension to the third tape tension can be done continuously. For example, it may be planned that the tape tension is reduced linearly over time from the second tape tension to the third tape tension. However, it may also be provided that the reduction of the tape tension from the second tape tension to the third tape tension is described by another suitable functional relationship.

By appropriately controlling the tape tension when winding the label carrier tape onto the winding shaft, it is possible to prevent the tape tension of the inner windings of the winding roll wound onto the winding shaft from increasing with the increasing diameter of the label carrier tape wound onto the winding shaft in the receiving position.

A specific embodiment of the receiving apparatus 100 described in FIG. 1 is discussed below in FIGS. 2a and 2b.

According to the embodiment of FIG. 1, the receiving apparatus 200 shown in FIGS. 2a and 2b also comprises a feeding apparatus 203 and a receiving unit 216. Regarding the specific form of the feeding apparatus 203 and the receiving unit 216, reference is made to the descriptions in FIG. 1.

In the embodiment shown here, the feeding apparatus 203 comprises two pressure rolls 204, 205 which are arranged to be deflected in a plane perpendicular to an axis of rotation 217 of the winding shaft 206, by which, as already described in conjunction with FIG. 1, the label carrier tape 202 can be pressed onto the winding shaft 206 or the winding roll 208 in the receiving position 209 and onto the winding roll in the rest position 210. The pressure roll 205 is to be considered optional. The form of the feeding apparatus 203 with two pressure rolls 204, 205 discussed here is to be understood as exemplary. The feeding apparatus 203 can, for example, comprise only one or more than two pressure rolls.

The control of the deflection of the two pressure rolls 204, 205 can be carried out, as described in conjunction with FIG. 1, by a control unit 218 encompassed by the receiving apparatus 200.

The feeding apparatus 203 can further comprise a severing apparatus 213 for severing the label carrier tape 202 between the winding roll in the receiving position 209 and the winding roll in the rest position 210. As shown in FIGS. 2a and 2b, the severing apparatus 213 can be arranged in a region next to the pressure roll 205. Optionally, the severing apparatus 213 can be associated with a pivotable plate, not explicitly shown in FIGS. 2a and 2b, which can be pivoted between the winding roll 208 in the receiving position 209 and a winding roll in the rest position 210. A plane in which the plate can be pivotably arranged can be perpendicular to the axis of rotation 217 of the winding shaft 206. In the embodiment shown here, the severing apparatus is configured as a cutting apparatus. However, the severing apparatus can also be configured in any other way suitable for severing the label carrier tape.

Optionally, the feeding apparatus 203 can further comprise at least one guide or deflection roll, not explicitly shown here, by which the label carrier tape 202 can be guided or deflected in the receiving apparatus 200. For example, two guide rolls can optionally be arranged upstream of the pressure roll 204 with respect to a guide direction of the label carrier tape 102 and provided for guiding the label carrier tape 102 in the receiving apparatus 200.

As already explained in FIG. 1, to which reference is made here, the receiving apparatus 200 can also comprise a drive apparatus 207 by which the winding shaft 206 can be set into rotation 214. Furthermore, the winding shaft 206 can be moved along a first direction 211 and a second direction 212, wherein the second direction 212 is antiparallel to the first direction 211.

FIGS. 2a and 2b show two different operating states of the receiving apparatus 200, wherein in FIG. 2a the winding shaft 206 is in a first position in which the label carrier tape 202 is wound onto a winding roll 208 in the receiving position 209 on the winding shaft 206. In the operating state shown in FIG. 2b, the winding shaft 206 is moved along the direction 211 into a second position, wherein, by moving the winding shaft 206, the winding roll, which is in the receiving position in FIG. 2a, is moved into a rest position 210 in the operating state of FIG. 2b and the label carrier tape 202 is wound into a new winding roll in the receiving position 209.

Before putting the receiving apparatus 200 into operation and winding the label carrier tape 202 onto the winding shaft 206 in the receiving position 209 as shown in FIG. 2a, it may be provided that the label carrier tape 202 is attached to the winding shaft 206 in the receiving position 209 by the labeling apparatus 201 via the feeding apparatus 203 and the winding shaft 206 is rotated several times, for example once, twice, three times, four times, or by any other number of revolutions, in order to secure the label carrier tape 202 to the winding shaft 206. This initialization process can be carried out manually by an operator or automatically by an initialization apparatus.

Subsequently, the label carrier tape 202 can be wound onto a winding roll 208 by rotating the winding shaft 206, as shown in FIG. 2a. During the winding process, the pressure roll 204 can be in a pressure position as shown in FIG. 2a, in which it is in contact with the winding roll 208 and supports the winding of the label carrier tape 202 onto the winding roll 208 in the receiving position 209.

If the winding roll 208 is to be moved from the receiving position 209 to a rest position 210, for example because the winding roll 208 has received a maximum length of label carrier tape 202 in the receiving position 209, the pressure roll 204 can be moved from the pressure position to a release position by the control unit 218. In the release position, the pressure roll is no longer in contact with the winding roll 208 in the receiving position 209, thus allowing the winding roll 208 to move from the receiving position 209 to the rest position 210.

To move the winding roll into the rest position 210, the winding shaft 206 can be moved along the first direction 211, for example by a pneumatic or an electric linear drive, as already described in FIG. 1. During the movement of the winding shaft 206 along the first direction 211, it may be provided that a rotation speed of the winding shaft 206 is reduced compared to normal operation, in which the label carrier tape 202 is wound onto the winding roll 208 in the receiving position 209. By reducing the rotation speed during the movement, possible disturbance, which may be caused, for example, by the label carrier tape 202 becoming entangled, can be prevented. A value for the reduced rotation speed can be chosen, for example, depending on a property of the wound-up label carrier tape, such as its thickness, width, or density. Different values for different label carrier tapes can, for example, be stored in the storage apparatus of the control unit 218, so that the control unit 218 can control the rotation speed based on the label carrier tape used.

As shown in FIG. 2b, after the winding roll has been moved to the rest position 210, the pressure roll 204 can be brought back into the pressure position, i.e., into contact with the winding shaft 206, by the control unit 218, and the label carrier tape 202 entering the receiving apparatus 200 from the labeling apparatus 201 can be wound into a new winding roll 208 in the receiving position 209 by rotating the winding shaft 206. Optionally, the pressure roll 205 can also be brought into contact with the winding roll 219 in the rest position 210.

To separate a physical connection between the winding roll 208 in the receiving position 209 and the winding roll 219 in the rest position 210, the label carrier tape 202 can be cut by the severing apparatus 213 between the winding roll 208 in the receiving position 209 and the winding roll 219 in the rest position 210. The severing apparatus 213 can, for example, be configured to pivot along an axis which can be arranged parallel to the axis of rotation 217 of the winding shaft 206. Alternatively, the severing apparatus 213 for severing the label carrier tape 202 can also be configured to be movable linearly along one direction. The severing apparatus 213 can in turn be associated with a pivotable plate, not explicitly shown in FIGS. 2a and 2b, which can be pivoted in a plane perpendicular to the axis of rotation 217 of the winding shaft 206 and, after the label carrier tape 202 has been severed by the severing apparatus 213, can be pivoted between the winding roll 208 in the receiving position 209 and the winding roll 219 in the rest position 210 in order to guide the winding roll 219 in the rest position 210.

As shown in conjunction with FIG. 2b, the label carrier tape 202 can then be wound into a new winding roll 208 in the receiving position 209, while the winding roll 208, which was wound in the receiving position 209 in the process step shown in FIG. 2a, can now be held in the rest position 210 on the winding shaft 206.

By moving the winding shaft 206 along the second direction 212, the winding roll 219, which is in the rest position 210, can be stripped from the winding shaft 206. In this way, space can be created for a winding roll 208 that is currently in the receiving position 209. This can then be moved into the rest position 210 by again moving the winding shaft 206 along the first direction 211 and the label carrier tape 202 can be wound into a further winding roll in the receiving position. By moving the winding shaft 206 back and forth along the first 211 and the second direction 212, continuous receiving of the label carrier tape by the receiving unit 216 can thus be ensured.

To prevent the winding roll 208 from shifting in the receiving position 209 along the second direction 212 during the shifting of the winding shaft 206 along the second direction 212, the receiving unit can comprise a flange 215. The flange 215 can be arranged next to the receiving position 209, as shown in FIGS. 2a and 2b, and surround the winding shaft 206. One plane of the flange 215 can substantially run perpendicular to an axis 217 of rotation of the winding shaft 206. To avoid an unwanted shifting of the winding roll, the flange 215 can be arranged stationary with respect to the first 211 and second direction 212, so that the flange 215 is not shifted when the winding shaft 206 is shifted along the first 211 or second direction 212. In order to achieve rotation of the flange with the winding shaft despite the stationary arrangement of the flange along the first and second directions, the flange can be mechanically coupled to the winding shaft via a toothed connection, which allows it to be rotated synchronously with the winding shaft, but prevents movement of the flange along the first or second direction.

Since the tape tension of the inner layers of the winding roll increases with the increasing diameter of the winding roll wound on the winding shaft, it can happen that with large diameter winding rolls the winding roll can only be removed from the winding shaft under great force. To prevent this, it can be provided that the winding shaft comprises at least two winding shaft profile strips, wherein one of the at least two winding shaft profile strips is fixedly arranged in a first recess of a surface region of the winding shaft along the axis of rotation, and a profile of the at least two winding shaft profile strips projects radially beyond a main body of the winding shaft. Furthermore, it may be provided that the flange comprises at least two flange profile strips, wherein the at least two flange profile strips are firmly connected to the flange and each of the at least two flange profile strips can be movably guided along the axis of rotation of the winding shaft in a second recess of the winding shaft. A profile of the at least two flange profile strips can extend radially beyond the main body of the winding shaft. In the receiving position, the winding roll can be at least partially wound onto the at least two flange profile strips, and when the winding shaft is shifted from the receiving position to the rest position, the winding roll can be stripped off the at least two flange profile strips by the at least two winding shaft profile strips.

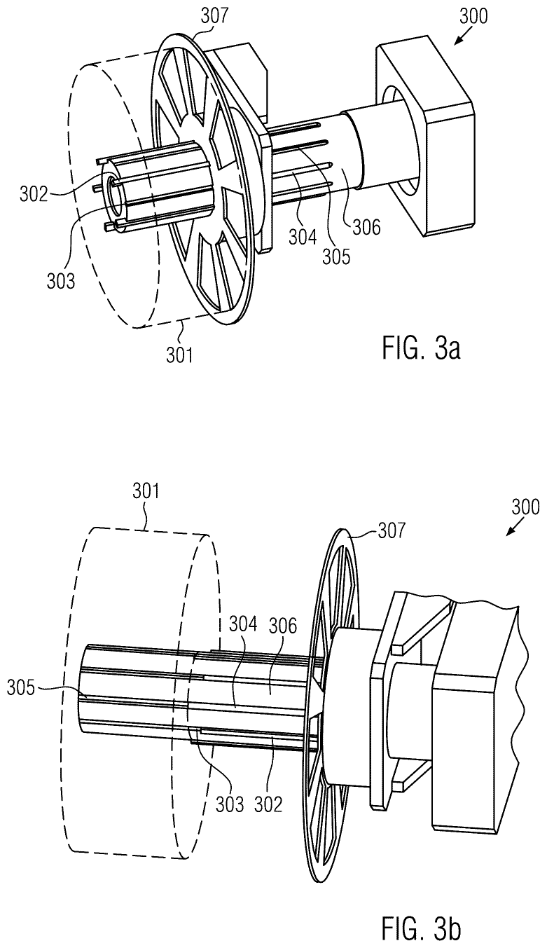

A winding shaft 306 of a receiving apparatus 300 equipped with winding shaft profile strips 304 and flange profile strips 302 is shown in conjunction with FIGS. 3a and 3b. The embodiment of FIGS. 3a and 3b can be combined with the embodiment of FIG. 1 and FIG. 2a and b.

The specific embodiment shown here, in which the winding shaft comprises five winding shaft profile strips 304 and five flange profile strips 302, is to be understood as exemplary. For example, the winding shaft can also comprise any other number of winding shaft profile strips 304, such as three, seven or ten, or any other number of flange profile strips 302, such as three, seven or ten. As shown in FIGS. 3a and 3b, a winding shaft profile strip 304 can be fixedly arranged in a first recess 303 of the winding shaft, and a flange profile strip 302 can be movably arranged in a second recess 305 of the winding shaft 306. The flange profile strips 302 can in turn be firmly connected to the flange 307.

A profile of the winding shaft profile strips 304 can protrude by a height h₁ beyond a main body of the winding shaft 306, on which the label carrier tape is wound. The profile of the flange profile strips 302 can protrude by a height h₂ beyond the main body of the winding shaft 306. The heights h₁ and h₂ can be identical or different from each other. The height h₁ can, for example, have a value of 1 mm, 2 mm, 5 mm or any other suitable value. The height h₂ can also have a value of 1 mm, 2 mm, 5 mm or any other suitable value.

As shown in FIGS. 3a and 3b, the winding shaft profile strips 304 and the flange profile strips 302 can be arranged equidistantly from each other along the circumference of the winding shaft 306. The winding shaft profile strips 304 and the flange profile strips 302 can each be arranged alternately along the circumference of the winding shaft 306. However, it may also be provided that the winding shaft profile strips 304 and the flange profile strips 302 are not arranged equidistantly along the circumference of the winding shaft.

As shown in FIG. 3a, the label carrier tape can first be wound in the receiving position in a first winding roll 301 on the winding shaft 306 and the flange profile strips 302 which are movably guided on the main body of the winding shaft along the axis of rotation. Because the profile of the flange profile strips 302, which are movably guided on the winding shaft 306, protrudes beyond the main body of the winding shaft 306, the inner layers of the label carrier tape lie against a surface between two flange profile strips when wound onto the winding shaft. Thus, the label carrier tape in the inner layers of the roll between two flange profile strips has a length that is greater than the distance between two flange profile strips. This prevents the label carrier tape from becoming constricted as the diameter of the winding roll increases.

For example, after the winding roll 301 has reached a certain diameter, a certain length of label carrier tape has been wound onto the winding roll 301, or the winding roll has reached a certain weight, it may be provided that the winding roll 301 is shifted from the receiving position to the rest position. This case is illustrated in FIG. 3b. For this purpose, the winding shaft can be moved along the first direction and the first winding roll can be stripped from the winding shaft 306 by the winding shaft profile strips 304. The winding shaft profile strips 304 can engage the first winding roll 301 in the regions between two flange profile strips 302 and strip the winding roll 301 from the flange profile strips 302 along the axis of rotation of the winding shaft.

The first winding roll can thus be moved into the rest position. In the receiving position, a second winding roll can then be wound onto the winding shaft 306, the flange profile strips 302 and the winding shaft profile strips 304. Here too, the label carrier tape can rub against a surface between an adjacent flange profile strip 302 and winding shaft profile strip 304 when being wound onto the winding shaft.

Once the second winding roll has reached a certain diameter or weight, or a certain length of label carrier tape has been wound onto the winding shaft, it may be provided that the winding shaft is moved in a direction antiparallel to the first direction. The first winding roll can be stripped from the winding shaft 306 in this way. The second winding roll can be held in the receiving position due to the flange 307. By shifting the winding shaft 306 in a direction antiparallel to the first direction, the winding shaft profile strips 304, which are firmly connected to the winding shaft, are pulled out from under the winding roll. The label carrier tape then lies on the winding shaft between two flange profile strips. The label carrier tape can then be wound further onto the winding roll until, for example, the winding roll has reached a target diameter or a target weight, or a target length of label carrier tape has been wound onto the winding roll.

Subsequently, the winding shaft 306 can be shifted again along the first direction and the second winding roll can be moved by the winding shaft profile strips 304 from the flange profile strips 302 towards the rest position. In the receiving position, another winding roll can then be wound onto the winding shaft 306, the winding shaft profile strips 304 and the flange profile strips 302.

This process can be repeated as often as desired, thus ensuring continuous operation of a labeling apparatus upstream of the receiving apparatus.

Optionally, the receiving apparatus shown in conjunction with the embodiments of FIG. 1, FIGS. 2a and 2b, or FIGS. 3a and 3b may also comprise an adjustable flange. The adjustable flange can, for example, be embodied as a rotatable roll, wherein one axis of rotation of the rotatable roll can be perpendicular to the axis of rotation of the winding shaft. The adjustable flange can be configured to be movable along the axis of rotation of the winding shaft and can be brought into contact with a side surface of the winding roll guided on the winding shaft opposite the flange.

The adjustable flange can, for example, be brought into contact with a winding roll guided on the winding shaft when a certain type of label carrier tape is wound onto the winding shaft. The label carrier tape may shift slightly along the axis of rotation when wound onto the winding roll. This effect can occur in particular with winding roll diameters that are greater than or equal to 50% of a maximum winding roll diameter. This effect can be prevented by the adjustable flange.

The adjustable flange can be configured as a roll, as described above. The roll can comprise a plurality of roll segments, thus compensating for speed differences of the winding roll at different diameters.

The delivery of the adjustable flange can be provided, for example, when a single winding roll is arranged on the winding shaft. Before the winding roll is shifted into the rest position, the adjustable flange can be moved away from the winding roll or winding shaft along the axis of rotation in the first direction, thus allowing the winding roll to be moved from the receiving position to the rest position.

I claim:

1. A receiving apparatus for a label carrier tape of a labeling apparatus for containers, wherein the receiving apparatus comprises:
a feeding apparatus and a receiving unit, wherein the feeding apparatus can feed the label carrier tape to the receiving unit, wherein the receiving unit comprises a winding shaft which can be set in rotation by a drive apparatus and wherein the label carrier tape can be wound onto the winding shaft in a receiving position into a winding roll, wherein the winding shaft is configured to be moved in a first direction parallel to an axis of rotation of the winding shaft, wherein the winding roll can be moved from the receiving position to a rest position by moving the winding shaft and wherein the incoming label carrier tape can be wound onto a further winding roll in the receiving position.

2. The receiving apparatus for a label carrier tape according to claim 1, wherein the feeding apparatus comprises at least one pressure roll arranged along a direction parallel to the axis of rotation of the winding shaft, wherein a first pressure roll is provided in a region of the receiving position to press the label carrier tape against the winding shaft or the winding roll at the receiving position, wherein the first pressure roll can be deflected in a plane perpendicular to the axis of rotation of the winding shaft, wherein optionally a second pressure roll is provided in the region of the rest position to press the label carrier tape against the winding roll in the rest position, wherein the second pressure roll can be deflected in a plane perpendicular to the axis of rotation of the winding shaft.

3. The receiving apparatus for a label carrier tape according to claim 2, wherein the receiving apparatus comprises a control unit, wherein the control unit is configured to move the first pressure roll in the region of the receiving position from a pressure position to a release position in order to allow the movement of the winding roll from the receiving position to the rest position, wherein the control unit is configured, after the movement of the winding roll from the receiving position to the rest position, to move the first pressure roll in the region of the receiving position to the winding shaft in order to press the incoming label carrier tape against the winding shaft and optionally to move the second pressure roll in the region of the rest position to the winding shaft in order to press the label carrier tape against the winding roll in the region of the rest position.

4. The receiving apparatus for a label carrier tape according to claim 3, wherein the feeding device comprises a severing apparatus, wherein the label carrier tape between the winding roll in the rest position and the winding roll in the receiving position can be severed by the severing apparatus, wherein the severing apparatus comprises a guide disc for guiding the separated label carrier tape and/or the winding roll in the rest position, wherein the control unit is configured to move the winding shaft along a second direction, which runs antiparallel to the first direction, in order to release the winding roll held by the winding shaft in the rest position from the winding shaft and to guide the released winding roll out of the receiving apparatus.

5. The receiving apparatus for a label carrier tape according to claim 4, wherein the receiving unit comprises a flange, wherein the flange surrounds the winding shaft and a plane of the flange is substantially perpendicular to the axis of rotation of the winding shaft, wherein the flange is arranged stationary with respect to the first and second directions, wherein the winding roll in the receiving position can be held in the receiving position by the flange when the winding shaft is shifted along the second direction and shifting of the winding roll can be prevented.

6. The receiving apparatus according to claim 5, wherein the winding shaft comprises at least two winding shaft profile strips, wherein one of the at least two winding shaft profile strips is fixedly arranged in a first recess of a surface region of the winding shaft along the axis of rotation, wherein a profile of the at least two winding shaft profile strips projects radially beyond a main body of the winding shaft, wherein the flange comprises at least two flange profile strips, wherein the at least two flange profile strips are fixedly connected to the flange, and wherein one of the at least two flange profile strips can be movably guided along the axis of rotation of the winding shaft in a second recess of the winding shaft, wherein a profile of the at least two flange profile strips projects radially beyond the main body of the winding shaft, wherein the winding roll can be at least partially wound onto the at least two flange profile strips in the receiving position, and wherein, when the winding roll is shifted from the receiving position to the rest position, the winding roll can be stripped off the at least two flange profile strips by the at least two winding shaft profile strips.

7. The receiving apparatus for a label carrier tape according to claim 1, wherein the receiving apparatus comprises a sensor apparatus, preferably an ultrasonic sensor, for determining a parameter related to the winding of the label carrier tape onto the winding roll in the receiving position, wherein the control unit is configured to move the winding shaft along the first direction or the second direction based on the parameter.

8. The receiving apparatus for a label carrier tape according to claim 1, wherein the receiving apparatus comprises an apparatus for reducing the label carrier tape width, wherein the apparatus for reducing the label carrier tape width is arranged upstream of the feeding apparatus, and wherein the apparatus for reducing the label carrier tape width is optionally configured as a cutting apparatus or as a folding apparatus.

9. A method for receiving a label carrier tape of a labeling apparatus for containers into a receiving apparatus, wherein the receiving apparatus includes a feeding apparatus and a receiving unit, wherein the feeding apparatus feeds the label carrier tape to the receiving unit, wherein the receiving unit comprises a winding shaft which can be set in rotation by a drive apparatus, the method comprising:
winding the label carrier tape onto the winding shaft in a receiving position into a winding roll, wherein the winding shaft is moved at least temporarily in a first direction parallel to an axis of rotation of the winding shaft, wherein the winding roll is moved from the receiving position to a rest position by moving the winding shaft and the incoming label carrier tape is wound onto a further winding roll in the receiving position.

10. The method according to claim 9, wherein the feeding apparatus comprises at least one pressure roll arranged along a direction parallel to the axis of rotation of the winding shaft, wherein a first pressure roll is provided in a region of the receiving position to press the label carrier tape against the winding shaft or the winding roll in the receiving position, wherein the first pressure roll can be deflected in a plane perpendicular to the axis of rotation of the winding shaft, wherein optionally a second pressure roll is provided in the region of the rest position to press the label carrier tape against the winding roll in the rest position, wherein the second pressure roll can be deflected in a plane perpendicular to the axis of rotation of the winding shaft.

11. The method according to claim 10, wherein the receiving apparatus comprises a control unit, wherein the first pressure roll is moved by the control unit from a pressure position to a release position in the receiving position region to allow the winding roll to move from the receiving position to the rest position, wherein once the winding roll has moved from the receiving position to the rest position, the first pressure roll is moved by the control unit in the receiving position region to the winding shaft to press the incoming label carrier tape against the winding shaft, and optionally the second pressure roll is moved in the rest position region to the winding shaft to press the label carrier tape against the winding roll in the rest position region.

12. The method according to claim 11, wherein the feeding device comprises a severing apparatus, wherein the label carrier tape between the winding roll in the rest position and the winding roll in the receiving position is cut by the severing apparatus, wherein the severing apparatus comprises a guide disc for guiding the separated label carrier tape and/or the winding roll in the rest position, wherein the winding shaft is moved by the control unit along a second direction, which runs antiparallel to the first direction, and the winding roll held by the winding shaft in the rest position is released from the winding shaft and the released winding roll is guided out of the receiving apparatus.

13. The method according to claim 12, wherein the receiving unit comprises a flange, wherein the flange surrounds the winding shaft and a plane of the flange is substantially perpendicular to the axis of rotation of the winding shaft, wherein the flange is arranged stationary with respect to the first and second directions, wherein the winding roll in the receiving position can be held in the receiving position by the flange when the winding shaft is shifted along the second direction and shifting of the winding roll can be prevented.

14. The method according to claim 13, wherein the winding shaft comprises at least two winding shaft profile strips, wherein one of the at least two winding shaft profile strips is fixedly arranged in a first recess of a surface region of the winding shaft along the axis of rotation, wherein a profile of the at least two winding shaft profile strips projects radially beyond a main body of the winding shaft, wherein the flange comprises at least two flange profile strips, wherein the at least two flange profile strips are fixedly connected to the flange and wherein one of the at least two flange profile strips is movably guided along the axis of rotation of the winding shaft in a second recess of the winding shaft, wherein a profile of the at least two flange profile strips projects radially beyond the main body of the winding shaft, wherein the winding roll is at least partially wound onto the at least two flange profile strips in the receiving position, and wherein, when the winding roll is shifted from the receiving position to the rest position, the winding roll is stripped off the at least two flange profile strips by the at least two winding shaft profile strips.

15. The method according to claim 9, wherein the receiving apparatus comprises a sensor apparatus, preferably an ultrasonic sensor, for determining a parameter related to the winding of the label carrier tape onto the winding roll in the receiving position, wherein the winding shaft is moved along the first direction or the second direction by the control unit based on the parameter.
